(19) United States
(12) Patent Application Publication
(10) Pub. No.: US 2007/0077930 A1
(43) Pub. Date: Apr. 5, 2007

(54) Network and a network element and method of operation therefor

(75) Inventor: Maarten Peter Bodlaender, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/575,411

(22) PCT Filed: Oct. 1, 2004
(86) PCT No.: PCT/IB04/51940

§ 371 Date: Apr. 10, 2006

(30) Foreign Application Priority Data
Oct. 13, 2003 (EP) 03103772.4

(51) Int. Cl. H04Q 7/20

(52) U.S. Cl. 455/445

(57) ABSTRACT

The invention relates to a network (100). A first network element (103) communicates a physical characteristic message comprising information related to at least one physical characteristic of the first network element (103). The physical characteristic message may for example include information related to the size, shape, color etc. of the first network element (103). A second network element (105) comprises a receiver (111, 113) for receiving the physical characteristic message from the first network element (103). In addition, it has a sensor (11,7) for determining physical sensor information related to a physical characteristic of a physical environment of the second network element (105). The sensor (117) may for example be a video camera. A context processor (115) determines a physical context characteristic in response to the received physical characteristic message and the physical sensor information. For example, it may determine a position of other network elements based on a visual object algorithm using the received physical characteristics information.

The invention relates to a network and a network element and method of operation therefor and in particular for dynamic networks comprising context aware network elements.

In recent years, networking of electronic devices has become of increasing importance. Networking of personal computers based on wires or optical fibres has been known for some decades. However, in the last decade, networking of personal computers has become much more widespread as witnessed by the explosive growth of the Internet. In addition, an increasing number of standards for wireless networking have been developed, and it is expected that the adoption and introduction of wireless networking will be very significant over the next years.

In addition to the expected growth of wireless networking, it is also expected that an increasing number and types of electronic devices will be networked in the future and that networking will be deployed in fields traditionally not associated with networking. For example, it is expected that home networking where different home appliances and consumer equipment will be networked together will become increasingly widespread. For example, it is expected that networks may be used to electronically distribute stored music around a house from a central storage device. As another example, a household appliance such as a washing machine may be networked with, say, a TV, thereby allowing a message to be displayed on the TV when the washing machine has finished.

Examples, of wireless networks include WiFi (Trademark) and IEEE standards 802.11a, b and g which have been developed mainly for wireless computer and home networks.

Also a number of communication protocols and service frameworks have been developed for wired and wireless networks including for example Universal Plug and Play (UPnP) and Rendezvous protocols. These frameworks allow for automatic detection of devices and the services they offer, and for sharing of services over the network.

Most currently developed wireless networks tend to be dynamic networks where the configuration and operating conditions change dynamically as new network elements enter and leave the network. For example, a portable wireless network element such as a network connected Personal Digital Assistant (PDA) may enter the network when it is brought into the house and leave the network when the PDA is taken out of the house. In a dynamic network, the configuration may automatically adapt to the PDA entering and leaving the network. An example of a dynamic network is an IEEE 802.11 network operating in an ad-hoc or infrastructure mode.

In most dynamic networks, a centralized access point is included to which the wireless network elements communicate. Typically, the access point also bridges a wireless and wired section of the network. Communication between two wireless network elements is performed using the access point as an intermediate network element. Hence, data from one wireless network element is routed through the access point to another wireless network element. A plurality of access points may be provided in a wireless network and data may be routed between these to effect a communication connection.

Many wireless network standards including home network standards and protocols have a device detection function known as “discovery”, which allows devices to discover which other devices are currently present in the network. Typically, devices either search for other devices and/or devices announce themselves. For example, applications that require an up-to-date view of a home network tend to use a mix of these two mechanisms to optimize the consistency of the generated network overview. A search may be instigated by a device unicasting or broadcasting a search message and all devices receiving the message may reply by transmitting one or more device identities to the search device.

Context aware applications have been developed which need to determine the physical presence of other devices. However, discovery functions only include information related to the logical or structural organisation of the network.

Typically, no accurate co-ordinates are available to the network devices (for example GPS is not accurate enough for indoor use), and therefore any location information is either entered manually or based on distance estimations.

Accordingly, a number of network elements for dynamic networks exist which comprise sensors for generating sensor inputs related to the physical environment in which the network element exists. For example, network elements may comprise video cameras and employ computer vision algorithms for determining aspects related to the visual environment in which the network elements are located.

Physical sensor inputs enable implementation of context aware applications such as for example location based services. However, algorithms based on physical sensor inputs tend to have a relatively low reliability. They furthermore tend to have limited capabilities and efficiency. Also, services based on physical sensor inputs tend to have a relatively low dynamic performance due to the processing and averaging of sensor inputs required for sufficiently reliable performance. For example, a service based on object recognition will tend to require substantial processing and averaging in order to detect objects in video images obtained from a video camera.

As an example, in computer vision techniques, it is becoming possible to recognize objects, but this is a complex and typically unreliable operation. For example, in robotics positioning systems, computer vision techniques are used to recognize “land marks”, and navigation is based on recognizing landmarks if no absolute coordinates are available. Choosing the right landmarks is often based on how easy the landmark is to re-recognize. Clearly, it would be beneficial if devices could detect each other's physical presence, without requiring a large positioning infrastructure to be added to the network.

Hence, an improved network and network element would be advantageous and in particular one allowing for improved determination of a physical context of a network element and in particular for physical context related applications, algorithms and services having increased flexibility, reduced resource requirement, increased reliability, improved dynamic performance and/or enhanced or additional functionality.

Accordingly, the present invention preferably seeks to mitigate, alleviate or eliminate one or more of the above mentioned disadvantages singly or in any combination.

According to a first aspect of the invention, there is provided a network comprising: a first network element comprising: means for communicating a physical characteristic message comprising information related to at least one physical characteristic of the first network element; and a second network element comprising: a sensor for determining physical sensor information related to a physical characteristic of a physical environment of the second network element; a receiver for receiving the physical characteristic message from the first network element; and means for determining a physical context characteristic in response to the received physical characteristic message and the physical sensor information.

The invention may allow facilitated and/or enhanced determination of physical context information. For example, the invention may allow facilitated, faster and/or more reliable detection of the first network element in the physical context of the second network element The invention may furthermore allow new, enhanced or improved context aware services.

The invention may reduce a requirement for additional sensors (e.g. of different types) and allow for physical context information to be derived based on existing sensors of for example audiovisual equipment.

The physical characteristic message may for example be broadcast or may be transmitted specifically to the second network element. The physical characteristic of the first network element may for example relate to an object associated with the first network element such as an object in which the first network element is comprised or for which the first network element performs the communication. Thus, the reference to the first network element includes not only a physical unit comprising the communication functionality but also e.g. any physical entity for which the communication functionality performs communication.

According to a feature of the invention, the at least one physical characteristic comprises information of a physical property of the first network element.

The physical property may for example be related to a physical property of an object comprising the first network element such as for example a size, weight or color. The feature may facilitate object detection or recognition of the first network element. It may alternatively or additionally allow improved determination of physical characteristics of the first network element. For example, information of the size of the first network element and a relative size measured at the second network element may be used to determine a distance between the first and second network element.

According to a feature of the invention the at least one physical characteristic comprises a visual property of the first network element. The physical characteristic may for example be a three-dimensional or two-dimensional characteristic such as a shape of the first network element. This allows for facilitated context environment determination such as for example visual object recognition.

According to a feature of the invention, the physical characteristic message comprises an image of at least part of the first network element. This enables an efficient and easy to implement communication of visual context information, thereby facilitating visual context determination.

According to a feature of the invention, the at least one physical characteristic comprises a current characteristic of a physical signal being transmitted by the first network element For example, information related to a video or audio signal may be comprised in the physical characteristic message. This may facilitate detection of the first network element by the second network element from the transmitted physical signal.

According to a feature of the invention, the physical characteristic message comprises a data representation of the physical signal. This feature may facilitate communication of the physical characteristic information. For example, the data representation may comprise a compressed data representation of an audio or video signal being transmitted by the first network element. The compression may be a lossy compression enabling low bit rate. Preferably the compressed data representation comprises sufficient data to allow for a similarity detection. For example audio fingerprint techniques may be used. It may furthermore allow a very accurate object detection of the first network element.

According to a feature of the invention, the first network element comprises means for embedding a marker in the physical signal and the physical characteristic message comprises information related to the marker. For example, the first network element may embed a recognizable pattern such as a watermark in the physical signal. The physical characteristic message may facilitate detection of the marker and thus of the physical signal by the second network element.

According to a feature of the invention, the sensor is an image sensor. The image sensor may for example be a video camera or a still picture camera.

According to a feature of the invention, the means for determining is operable to determine the physical context characteristic by a visual detection algorithm responsive to the physical characteristic message. This feature may enable services based on the visual physical context of the second network element and in particular based on visually detected objects in the physical environment of the second network element.

According to a feature of the invention the visual detection algorithm is an object recognition algorithm. This feature may enable or facilitate identification of objects in the physical environment of the second network element.

According to a feature of the invention, the sensor is an audio sensor. This feature may enable services based on the audio physical context of the second network element.

According to a feature of the invention, the first network element furthermore comprises a movement detector and means for updating the physical characteristic message in response to a detected movement The movement detector may for example be a shock detector operable to detect a movement of the first network element.

According to a feature of the invention the physical context characteristic is a location of the first network element. This may facilitate or allow improved services or algorithms and in particular location based services and algorithms.

According to a feature of the invention the network further comprises a plurality of network elements operable to communicate physical characteristic messages and the second network element further comprises means for determining a physical location map of a plurality of network elements in response to the physical sensor information and received physical characteristic messages. The feature may allow or facilitate a location based service wherein locations of a plurality of network elements may e.g. automatically or semi-automatically be determined and presented to a user.

According to a feature of the invention, the means for determining a physical location map is further operable to determine the physical location map in response to a movement of the second network element. This may enhance an area covered by the physical location map and/or may improve the accuracy of the map.

According to a feature of the invention the first network element further comprises means for presenting an information signal to a user. The information signal may for example be an audio signal and/or a video signal.

The network is preferably a partly wireless network wherein some or possibly all of the communication links are formed by wireless communication links. Specifically the network may be a partly wireless network comprising both wired and wireless links which are bridged using access points.

The network is preferably a dynamic network wherein communication links may dynamically and adaptively update the configuration of the network. For example, the network may be a dynamic IEEE 802.11 netwotk including devices in infrastructure and/or ad-hoc mode.

According to a second aspect of the invention, there is provided a network element for a network comprising: a sensor for determining physical sensor information related to a physical characteristic of a physical environment of the network element; a receiver for receiving a physical characteristic message from a different network element the physical characteristic message comprising information related to at least one physical characteristic of the different network element; and means for determining a physical context characteristic in response to the received physical characteristic message and the physical sensor information.

According to a third aspect of the invention, there is provided a method of operation in a network comprising the steps of: communicating from a first network element a physical characteristic message comprising information related to at least one physical characteristic of the first network element; and at a second network element performing the steps of: determining physical sensor information from a sensor, the physical sensor information being related to a physical characteristic of a physical environment of the second network element; receiving the physical characteristic message from the first network element; and determining a physical context characteristic in response to the received physical characteristic message and the physical sensor information.

These and other aspects, features and advantages of the invention will be apparent from and elucidated with reference to the embodiments described hereinafter.

An embodiment of the invention will be described, by way of example only, with reference to the drawing, in which:

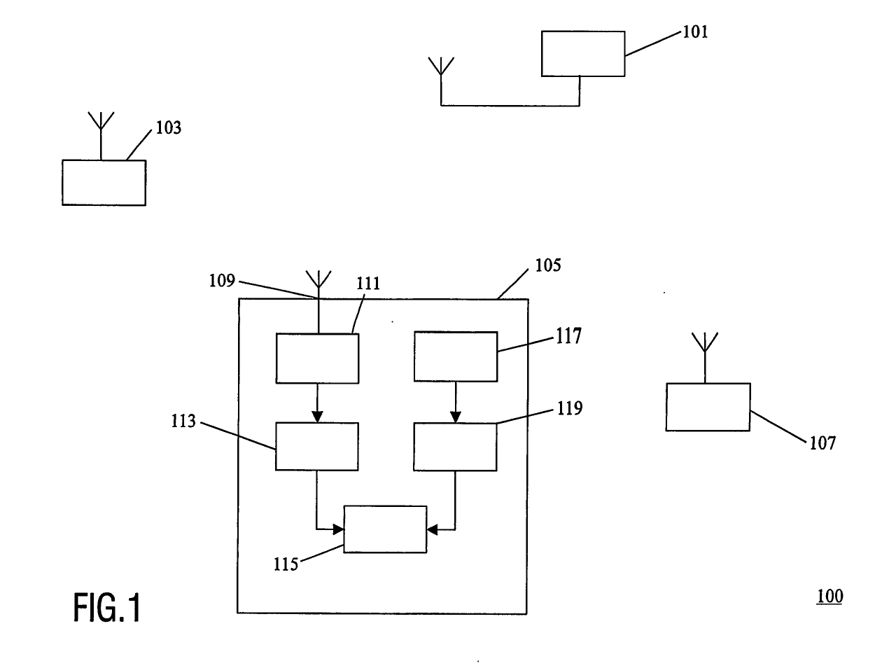

FIG. 1 is an illustration of a wireless communication network in accordance with an embodiment of the invention.

The following description focuses on an embodiment of the invention applicable to a wireless communication network such as a WiFi or IEEE 802.11 communication network. However, it will be appreciated that the invention is not limited to this application but may be applied to many other communication networks.

FIG. 1 is an illustration of a wireless communication network 100 in accordance with an embodiment of the invention.

The illustrated wireless communication network comprises a single access point 101 to (and through) which all wireless network elements communicate. For brevity and clarity, the wireless communication network 100 of FIG. 1 is illustrated comprising three network elements 103, 105 and 107 but it will be appreciated that a practical wireless communication network may comprise many more active or inactive network elements. It will be appreciated that the access point 101 may be connected to other access points or network elements through wired communication links. Thus, the access point 101 may function as a bridge between wired and wireless sections of a partly wireless network.

In the illustrated example, the different network elements may for example correspond to personal computers, consumer electronic devices, home appliances, printer servers, personal digital assistants, audiovisual equipment or any other suitable type of device.

In the specific embodiment, a first network element 103 at regular intervals transmits announcement messages comprising device identification and information. The announcement messages are broadcast by the access point 101.

The second network element 105 is operable to receive and process the announcement messages. In addition, the second network element 105 is operable to transmit enquiry messages which are broadcast by the access point 101. In the described embodiment, the third network element 107 is operable to generate an enquiry response message comprising device identification and to transmit this to the second network element 105, which is operable to receive and process this. Thus, the second network element 105 will in the described example receive device identification and information from other network elements.

The second network element 105 comprises one or more sensors which can perceive aspects of the physical environment in which the second network element 105 operates. For example, the second network element may process a video sensor signal to provide various services based on visual inputs. In some embodiments, the second network element 105 may for example visually detect the location of objects including objects associated with the other network elements 101, 107.

However, processing based on sensor signals only tends to result in performance which may be slow, unreliable, complex, limited and sub-optimal. For example, object detection based on a sensor signal from a visual camera may be both complex and unreliable and may be based on many assumptions about the objects being detected. E.g., detection of an object such as loudspeakers in an AV environment will typically be based on assumptions on the loudspeakers shape, size and color. These assumptions may be more or less correct (for example specially designed speakers can be unrecognizable without additional information), thereby leading to unreliable and variable detection of the loudspeakers in the visual sensor signal.

In accordance with an embodiment of the present invention, processing of sensor signals may be facilitated and/or improved by the use of information related to one or more physical characteristic of other network elements to be detected.

In the following, an embodiment of the invention will be described with reference to a specific example application. In the example, the first network element 103 comprises five loudspeakers connected to a wireless network communication unit. The third network element 107 comprises a large screen video monitor with an embedded wireless network communication unit. The video monitor and loudspeakers together form an audiovisual presentation arrangement wherein the video monitor presents a visual image and the loudspeakers present the associated surround sound.

It will be appreciated, that the term network element relates not only to the communication facility but also to any object associated therewith. Thus, the network element is considered to include any object for which the communication functionality transmits physical characteristics information.

In accordance with an embodiment of the present invention, both the first and third network element 103, 107 have information stored related to physical characteristics of the network elements 103, 107. Specifically, the first network element 103 comprises information of the size, shape and color of each of the five speakers. Similarly, the third network element 107 comprises information of the size, shape and color of the video monitor.

In accordance with the present invention, the first network element 103 and the third network element 107 are operable to include the information related to the physical characteristics in a physical characteristic message. The network elements furthermore comprise means for communicating the physical characteristic message to other network elements including the second network element 105. Specifically, the physical characteristic message may be included in the announcement messages transmitted by the first network element 103 and the enquiry response messages transmitted by the third network element 107.

The functionality of the second network element 105 of the described embodiment is illustrated in more detail in FIG. 1 and will be described in more detail in the following.

The second network element 105 comprises an antenna 109 which receives the wireless radio signals transmitted by the access point 101 and feds these to a receiver 111. The receiver 111 comprises the required functionality for demodulating the received signal and generating the data of the received signal as is well known in the art.

The data is fed to an extraction processor 113 which is operable to detect the physical characteristic message and to extract the physical characteristics information therefrom. The extraction processor 113 is coupled to a context processor 115 which is operable to determine a physical context characteristic of the physical environment of the second network element 105. The extraction processor 113 is operable to feed the extracted physical characteristics information to the context processor 115. Thus, the context processor 115 is provided with information of the size, shape and color of the loudspeakers of the first network element 103 and the video monitor of the third network element 107.

The second network element 105 further comprises a video camera 117 which generates a sensor signal related to the physical visual environment of the second network element 105. The video camera 117 is coupled to a video camera interface 119 which generates a suitable digital representation of the images from the video camera The video camera interface 119 is coupled to the context processor 1 15 and feeds the digital representation to the context processor 115.

The context processor is operable to determine a physical context characteristic in response to the information received from the extraction processor 113 and the video camera interface 119.

In the described embodiment, the context processor 115 is operable to perform a visual detection algorithm and in particular an object detection algorithm. It will be appreciated that object detection algorithms from visual images are well known in the art and will not be described in detail herein. Typically, object recognition algorithms take visual sensor information and correlate it to a set of visual characteristics of objects to be recognized.

Specifically, the context processor 115 performs an object detection algorithm based on the physical information received in the physical characteristic message. Thus, the object detection algorithm in the described embodiment evaluates the images from the video camera 117 to detect objects of the size, shape and color of the first network element 103 and the third network element 107.

As a specific example, the second network element 105 may be placed in the center of a room in which the video monitor and loudspeakers are situated. The second network element 105 may furthermore comprise functionality for rotating the video camera 117 to generate a full 360° image. The context processor 115 may then search the image for five objects having the shape and color indicated by the physical characteristic message received from the first network element 103. For each object identified, the relative size of the object compared to the size indicated in the physical characteristic message may be used to determine a distance from the second network element 105 to the different loudspeakers. If more than five objects potentially matching the physical characteristics are found, various algorithms may be used for selecting the most likely matches. For example, a calculated distance below or above a given interval may be rejected. Similarly, the object detection algorithm evaluates the image for an object of the same shape and color as that received in the physical characteristic message from the third network element 107. It then determines the distance to the video monitor in response to the relative size in the image and the reported size in the physical characteristic message.

Accordingly, the second network element 105 may automatically detect the location of the five loudspeakers and the video monitor in the room. The detection speed and reliability is significantly improved due to the physical characteristic message received from the other network elements and indeed the feasibility and practicality of the application may be dependent on the availability of the physical characteristic message. Thus, the described embodiment may enable additional and/or enhanced and/or improved services.

It will be appreciated that the determination of the location of the different objects may be used in many different ways and for many different goals depending on the specific application. For example, the second network element 105 may be used to automatically detect and evaluate the audiovisual setup. For example, it may automatically generate suggestions of a modified placement of speakers resulting in improved surround sound performance or it may calculate a preferred or optimal user position for the optimal surround sound effect.

In the embodiment described above, simple physical measurements were provided to the second network element 105 by the other network elements 103, 107. This information may be communicated by only a small amount of data and may thus be comprised in short data messages. In other embodiments, more substantial data amounts with more detailed information may be communicated. For example, the first and third network element 103, 107 may transmit a range of images of the loudspeakers and/or video monitor. For example, the images may be of the corresponding objects from a number of different angles. This information may substantially facilitate the object recognition by the context processor 115 and may specifically result in improved reliability of the detection of the objects in the visual environment of the second network element 105.

It will be appreciated that although the example embodiment uses a visual sensor input, any other suitable sensor inputs for determining characteristics of the physical environment of the second network element 105 may be used.

Specifically, an audio sensor, such as a microphone, may alternatively or additionally be used. Thus, the second network element 105 may preferable comprise sensor inputs for determining an audiovisual signal comprising both an audio and visual signal. This may for example be particularly useful for audiovisual applications. For example, the second network element 105 of the above described embodiment may additionally detect the relative volume levels from the five different loudspeakers. In a simple embodiment, a constant volume signal may sequentially be transmitted from each of the five loudspeakers and this may be detected by the second network element 105. This may not only allow an improved evaluation of the audio environment but may also be used to facilitate determination of the visual environment. For example, the relative volume level may be used to assist the determination of the distance from the second network element 105 to the individual loudspeakers.

In the described embodiment, the network elements comprise information related to inherent physical characteristics of the network elements. This allows for the information to be stored in the network elements, for example during manufacturing, and therefore provides a simple way of generating the physical information. However, in other embodiments, the network elements may for example be operable to alternatively or additionally determine dynamic or environment based physical characteristics of the network elements and to include this in the physical characteristic message. For example, the third network element 107 may determine whether the video monitor is mounted on a wall or placed on a stand. This information may facilitate detection of the video monitor by the second network element 105.

In some embodiments, the network elements are operable to transmit a presentation signal to a user. For example, in the above described embodiment the video monitor transmits a video image and the loudspeakers transmit an audio signal. In some embodiments, the physical characteristic message may comprise information of a current characteristic of the physical signal being transmitted by the network elements.

Thus, the third network element 107 may communicate a physical characteristic message that comprises information related to the video images that are being transmitted. This may allow improved object detection by the second network element 105. For example, if the second network element 105 has information indicating that a football match is being presented, it may select between two candidate objects in response to the amount of green color associated with each of these objects.

In some embodiments, a data representation of the physical signal may be included in the physical characteristic message. For example, a highly compressed MPEG-2 representation of the signal to be displayed on the video monitor may be included, thereby allowing for very accurate detection. However, this requires large amounts of data to be communicated which may be impractical in many applications. Therefore, more indirect information may often be used including for example information indicating the type of content being presented or audio fingerprint information.

In some embodiments, the network elements may be operable to embed a marker in the physical signal being presented. For example, the third network element 107 may include an infrequent visual characteristic which is not noticeable to a viewer. However, a distinct pattern may be detectable by the second network element 105, thereby allowing for an accurate detection of the object in the images from the video camera Information of the embedded marker may be included in the physical characteristic message, thereby allowing for the second network element 105 to receive this information and to use it in the object recognition. The marker is preferably sufficiently subtle so as not to be noticeable to the user and thereby may be embedded in a live presentation signal. In other embodiments, the marker may be a specific test signal. For example, the video monitor may transmit a specific sequence of colors during a test used by the second network element 105 to determine the physical context.

In some embodiments, the network elements transmitting physical characteristic messages may themselves be able to detect characteristics of their environment and to include this in the physical characteristic message. For example, the network elements may comprise a GPS receiver operable to detect a position of the network element and to include this in the physical characteristic message.

The network elements transmitting the physical characteristic message may additionally or alternatively comprise a movement detector. If the movement detector determines that the network element may have been moved, it may perform a reevaluation of the physical environment and transmit an updated physical characteristic message indicative of the new environment. The movement detector may for example be a simple shock detector.

A specific example of an application that may be enabled or facilitated by the transmission of the physical characteristic messages will be described in the following. In this example, a house may comprise a number of network elements of a dynamic network. These network elements may include televisions, audio surround sound amplifiers, loudspeakers, computers etc. Some or all of these network elements are operable to transmit physical characteristic messages via the dynamic network.

In this environment, a control network element may comprise a display and implement remote control functionality for some or all of the network elements. Thus, a user may use a single portable control network element to control many of the appliances and equipment located throughout the house. For example, the same control network element may control the volume of the surround sound, the operation of a DVD player and the light sources in one or more rooms.

In the described embodiment, the control network element is operable to determine a physical location map which indicates the location of some or all of the network elements in the house. Preferably, a plan of the house may be entered manually and the control network element may automatically determine the location of the other network elements and relate these to the plan. Specifically, the control network element may comprise a video camera which performs a visual detection of objects based on the received physical characteristic message as illustrated by the embodiment of FIG. 1.

The control network element is preferably moved around the house, automatically picking up physical characteristic messages and detecting the position of the various network elements. Hence, a location map may be automatically or semi-automatically determined and may be presented to a user on a suitable display which is preferably part of the control network element. Preferably, the control network element continuously or regularly performs the object detection, thereby allowing the control network to automatically detect changes to the position of any network element and to automatically update the location map.

The invention can be implemented in any suitable form including hardware, software, firmware or any combination of these. However, preferably, the invention is at least partly implemented as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with the preferred embodiment, it is not intended to be limited to the specific form set forth herein. Rather, the scope of the present invention is limited only by the accompanying claims. In the claims, the term comprising does not exclude the presence of other elements or steps. Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is no feasible and/or advantageous. In addition, singular references do not exclude a plurality. Thus references to “a”, “an”, “first”, “second” etc. do not preclude a plurality.

1. A network (100) comprising:
a first network element (103) comprising: means for communicating a physical characteristic message comprising information related to at least one physical characteristic of the first network element (103); and
a second network element (105) comprising:
a sensor (117) for determining physical sensor information related to a physical characteristic of a physical environment of the second network element (105);
a receiver (111, 113) for receiving the physical characteristic message from the first network element (103); and
means (115) for determining a physical context characteristic in response to the received physical characteristic message and the physical sensor information.

2. A network as claimed in claim 1 wherein the at least one physical characteristic comprises information of a physical property of the first network element (103).

3. A network as claimed in claim 1 wherein the at least one physical characteristic comprises a visual property of the first network element (103).

4. A network as claimed in claim 1 wherein the physical characteristic message comprises an image of at least part of the first network element (103).

5. A network as claimed in claim 1 wherein the at least one physical characteristic comprises a current characteristic of a physical signal being transmitted by the first network element (103).

6. A network as claimed in claim 5 wherein the physical characteristic message comprises a data representation of the physical signal.

7. A network as claimed in claim 5 wherein the physical signal is an audiovisual signal

8. A network as claimed in claim 5 wherein the first network element (103) comprises means for embedding a marker in the physical signal and the physical characteristic message comprises information related to the marker.

9. A network as claimed in claim 1 wherein the sensor (117) is an image sensor.

10. A network as claimed in claim 1 wherein the means (115) for determining is operable to determine the physical context characteristic by a visual detection algorithm responsive to the physical characteristic message.

11. A network as claimed in claim 1 wherein the visual detection algorithm is an object recognition algorithm.

12. A network as claimed in claim 1 wherein the sensor (117) is an audio sensor.

13. A network as claimed in claim 1 wherein the first network element (103) furthermore comprises a movement detector and means for updating the physical characteristic message in response to a detected movement.

14. A network as claimed in claim 1 wherein the physical context characteristic comprises a location of the first network element (103).

15. A network as claimed in claim 1 wherein the network (100) further comprises a plurality of network elements (103, 107) operable to communicate physical characteristic messages and wherein the second network element (105) further comprises means for determining a physical location map of a plurality of network elements (103, 107) in response to the physical sensor information and received physical characteristic messages.

16. A network as claimed in claim 1 wherein the means for determining a physical location map is further operable to determine the physical location map in response to a movement of the second network element (105).

17. A network as claimed in claim 1 wherein the first network element (103) further comprises means for presenting an information signal to a user.

18. A network as claimed in claim 1 wherein the network (100) is a partly wireless network.

19. A network as claimed in claim 1 wherein the network (100) is a dynamic network.

20. A network element (105) for a network (100) comprising:
a sensor (117) for determining physical sensor information related to a physical characteristic of a physical environment of the network element (105);
a receiver (111, 113) for receiving a physical characteristic message from a different network element (103, 107), the physical characteristic message comprising information related to at least one physical characteristic of the different network element(103, 107); and
means (115) for determining a physical context characteristic in response to the received physical characteristic message and the physical sensor information.

21. A method of operation in a network (100) comprising the steps of:
communicating from a first network element (103) a physical characteristic message comprising information related to at least one physical characteristic of the first network element (103); and
at a second network element (105) performing the steps of:
determining physical sensor information from a sensor (117), the physical sensor information being related to a physical characteristic of a physical environment of the second network element (105);
receiving the physical characteristic message from the first network element (103); and
determining a physical context characteristic in response to the received physical characteristic message and the physical sensor information.
